(19) United States
(12) Patent Application Publication
(10) Pub. No.: US 2005/0109610 A1
(43) Pub. Date: May 26, 2005

(54) Electrolytic water generation apparatus having stable performance of electrolytic water generation

(75) Inventors: Yoshihiro Inamoto, Osaka (JP); Yozo Kawamura, Osaka (JP); Minoru Kishi, Osaka (JP)

Correspondence Address: FOLEY AND LARDNER;SUITE 500, 3000 K STREET NW, WASHINGTON, DC, 20007, US

(73) Assignee: Sanyo Electric Co., Ltd.

(21) Appl. No.: 10/978,407

(22) Filed: Nov. 2, 2004

(30) Foreign Application Priority Data
Nov. 7, 2003 (JP) 2003-378334

(51) Int. Cl. C25D 17/00; C02F 1/461

(52) U.S. Cl. 204/229.5; 204/232

(57) ABSTRACT

Into an electrolytic bath storing water to be treated, saturated sodium chloride solution identified as an electrolysis accelerator is added from an electrolysis accelerator bath. The water to be treated is subjected to electrolysis. In the electrolytic bath, water to be treated is introduced from an inlet during the electrolysis process. The water subjected to electrolysis in electrolytic bath is output to a reservoir via an overflow port. A plurality of electrode pairs are provided in the electrolytic bath. During the electrolysis process, the value of the current flowing across the electrodes of the electrode pair arranged most upstream of a water channel from the inlet to the overflow port in the electrolytic bath is detected, and control is provided such that the current value is within a predetermined range by adjusting the concentration of the accelerator in the electrolytic bath.

### BACKGROUND OF THE INVENTION

1. Field of the Invention

The present invention relates to electrolytic water generation apparatuses, particularly an electrolytic water generation apparatus having a pair of electrodes immersed in water to be treated for converting the water to be treated into electrolytic water including a desired component by the electrolytic reaction of the electrode pair.

2. Description of the Related Art

The technique of a conventional electrolytic water generation apparatus that generates sodium hypochlorite used for sterilization in the water supply through electrolytic reaction is disclosed.

For example, Japanese Patent Laying-Open No. 07-216572 discloses the technique of an electrolytic water generation apparatus that dilutes saline with dilution water, and supplies the diluted saline to an electrolytic bath, whereby sodium hypochlorite is generated.

When water including mineral components such as tap water is used as the dilution water, the aforementioned electrolytic water generation apparatus had the problem that the scale and the like of the mineral component will adhere to the negative side of the electrodes. It is to be noted that the electrical resistance of the diluted saline varies depending upon the temperature. When the aforementioned electrolytic water generation apparatus is used at a cold district in the winter period, the electrical resistance of the diluted saline will be reduced together with the water temperature, leading to the flow of an extremely large current across the electrodes of the electrode pair in the electrolytic bath. There was a problem that the electrodes are consumed in a short period of time.

The aforementioned Japanese Patent Laying-Open No. 07-216572 also discloses the technique of providing a front electrolytic bath at a preceding stage of a main electrolytic bath that generates sodium hypochlorite to cause generation of scale in advance at the front electrolytic bath so as to suppress generation of scale at the main electrolytic bath, and also increasing the temperature of the diluted saline supplied to the main electrolytic bath in the electrolytic water generation apparatus.

In conventional electrolytic water generation apparatuses including the apparatus disclosed in Japanese Patent Laying-Open No. 07-216572, the quantative prospect of chemical agents such as saline directed to accelerating the electrolytic reaction at the time of introduction into the electrolytic bath was insufficient. The concentration of the chemical agent employed to accelerate the electrolytic reaction in the electrolytic bath varies in accordance with the electrolyzing period of time, whereby the performance of generating electrolytic water by the electrolytic water generation apparatus differs.

### SUMMARY OF THE INVENTION

In view of the foregoing, an object of the present invention is to provide an electrolytic water generation apparatus stable in the performance of generating electrolytic water.

An electrolytic water generation apparatus according to an aspect of the present invention includes an electrolytic bath storing water to be treated. The electrolytic bath includes an inlet through which the water to be treated is introduced, and an outlet from which the water subjected to electrolysis in the electrolytic bath is output. The electrolytic water generation apparatus also includes a plurality of electrode pairs arranged along a water channel from the inlet to the outlet in the electrolytic bath, a power supply control unit providing control such that a predetermined amount of power is supplied to each of the plurality of electrode pairs, a chemical agent supply unit supplying a chemical agent required to accelerate electrolysis of the water to be treated by the electrode pairs in the electrolytic bath, a current value detection unit detecting a first current value identified as the value of current flowing across electrodes constituting an electrode pair arranged most upstream in the water channel among the plurality of electrode pairs, and a second current value identified as the value of current flowing across electrodes constituting another electrode pair differing from the electrode pair arranged most upstream, when a predetermined amount of power is supplied to each of the plurality of electrode pairs, and a chemical agent amount control unit controlling the amount of chemical agent supplied by the chemical agent supply unit such that the first current value is within a predetermined range. When the second current value becomes at least a specific current value, the chemical agent amount control unit modifies the upper limit and the lower limit defining the predetermined range to respective lower values.

According to the present aspect of the present invention, electrolysis is executed on the water to be treated in the electrolytic bath. The amount of chemical agent supplied to the electrolytic bath, required to accelerate such electrolysis, is controlled so that the first current value is within a predetermined range. Therefore, the degree of acceleration of electrolysis on the water to be treated can be set constant.

Since a plurality of electrode pairs are arranged along the circulating path of the water to be treated in the electrolytic bath, circulation of the water to be treated allows the water to pass through the proximity of the plurality of electrode pairs.

When the second current value becomes equal to or higher than a specific current value, a predetermined current value identified as the value employed for control of the first current value is modified to a lower value. By the control of the first current value through a predetermined current value, the event of the second current value becoming too large, i.e., the event of load imposed on the second pair of electrodes and et seq. due to excessive current flowing to the electrode pair located as the second pair from the upstream side and subsequent electrode pairs even if a current of an appropriate value flows to the electrode pair located most upstream in the circulating path of the water to be treated, can be avoided.

The electrolytic water generation apparatus of the present invention preferably includes an abnormal event notify unit notifying an abnormal event on the condition that the lower limit of the predetermined range after modification by the chemical agent amount control unit becomes lower than a predetermined value.

Accordingly, the amount of current flowing to the second pair of electrodes and et seq. from the upstream side in the circulating path of the water to be treated in the electrolytic bath can be suppressed. Thus, excessive suppression of the value of current to be conducted to the electrode pair located most upstream can be inhibited.

According to another aspect of the present invention, an electrolytic water generation apparatus includes an electrode pair, an electrolytic bath storing the electrode pair and water to be treated, a chemical agent supply unit supplying in the electrolytic bath a solution of a chemical agent required to accelerate electrolysis of the water to be treated by the electrode pair, a chemical agent temperature detection unit detecting the temperature of the solution to be supplied by the chemical agent supply unit, and a chemical agent amount control unit controlling the amount of agent solution supplied to the electrolytic bath by the chemical agent supply unit based on the temperature detected by the chemical agent temperature detection unit.

According to the present aspect of the present invention, the amount of solution of the chemical agent required to accelerate electrolysis, supplied to the electrolytic bath where the electrolysis processing on the water to be treated is executed, is controlled based on the temperature of the solution of the chemical agent. In electrolysis, the conductivity of an electrolyte is affected by the temperature of the electrolyte. Therefore, the degree of acceleration of electrolysis of the water to be treated in the electrolytic bath can be set constant independent of the temperature of the solution of the chemical agent in the present aspect of the invention.

In the electrolytic water generation apparatus of the present invention, the chemical agent required to accelerate electrolysis of the water to be treated is preferably a chemical agent that supplies chloride ions into the water to be treated.

In the electrolytic water generation apparatus of the present invention, the chemical agent required to accelerate electrolysis of the water to be treated is preferably sodium chloride.

By the present invention, the degree of acceleration of electrolysis of the water to be treated in the electrolytic bath can be set constant. Therefore, the performance of generating electrolytic water in an electrolytic water generation apparatus including such an electrolytic bath can be set stable.

The flow of the water to be treated along the water channel ensures the passage in the proximity of the plurality of electrode pairs. Therefore, the electrolytic processing performance on the water to be treated in the electrolytic water generation apparatus can be improved.

By the present invention, the event of a relatively large current flowing to some of the electrode pairs to impose load on the relevant electrode pair can be avoided.

Furthermore, by the present invention, the degree of acceleration of electrolysis of the water to be treated in the electrolytic bath can be set constant independent of the temperature of the solution of the relevant agent. Therefore, the performance of generating electrolytic water can be made stable in the electrolytic water generation apparatus including such an electrolytic bath.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 and 2 schematically show a functional configuration of a water processing system including a first embodiment of an electrolytic water generation apparatus of the present invention.

FIG. 3 is a diagram to describe the arrangement of electrodes in the electrolytic bath of FIG. 1.

FIG. 4 is a control block diagram of the electrolytic water generation apparatus of FIG. 1.

FIG. 5 is a flow chart of the process executed by the control circuit of FIG. 4 when electrolysis processing is conducted in the electrolytic bath of FIG. 1.

FIG. 6 schematically shows the contents of determination criteria in the process of FIG. 5, stored in the memory of FIG. 4.

FIG. 7 is a flow chart of the process executed by the control circuit of the electrolytic water generation apparatus of the present invention according to the first embodiment when electrolysis processing is conducted in the electrolytic bath included therein.

### DESCRIPTION OF THE PREFERRED EMBODIMENTS

### First Embodiment

Embodiments of the present invention will be described hereinafter with reference to the drawings.

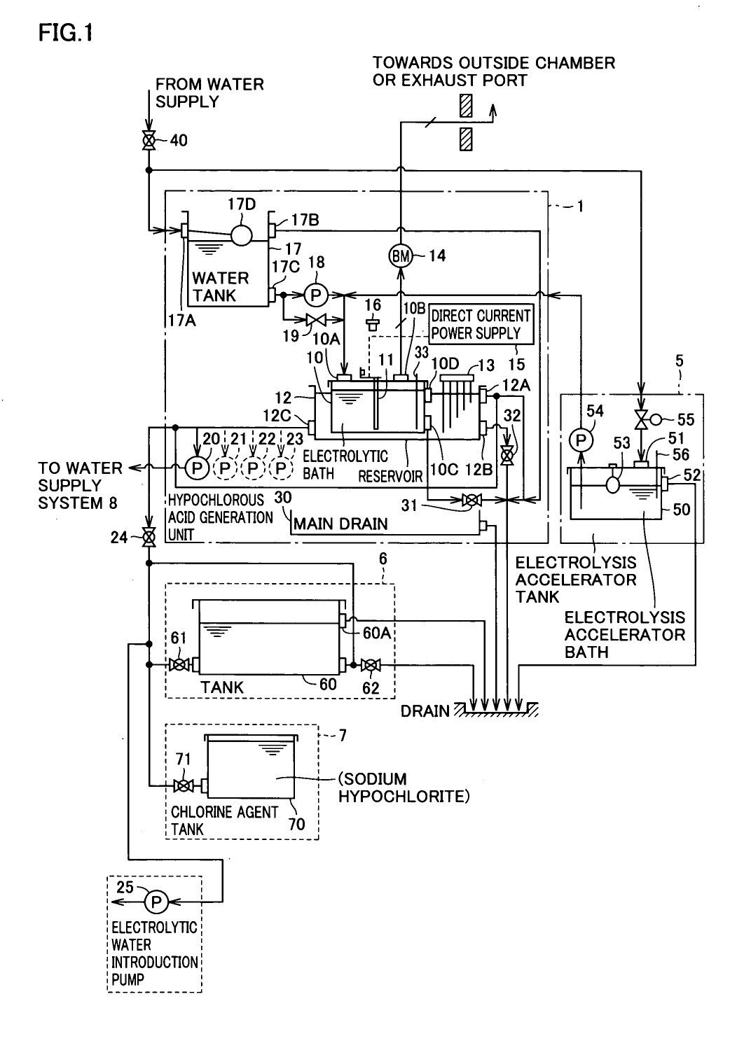

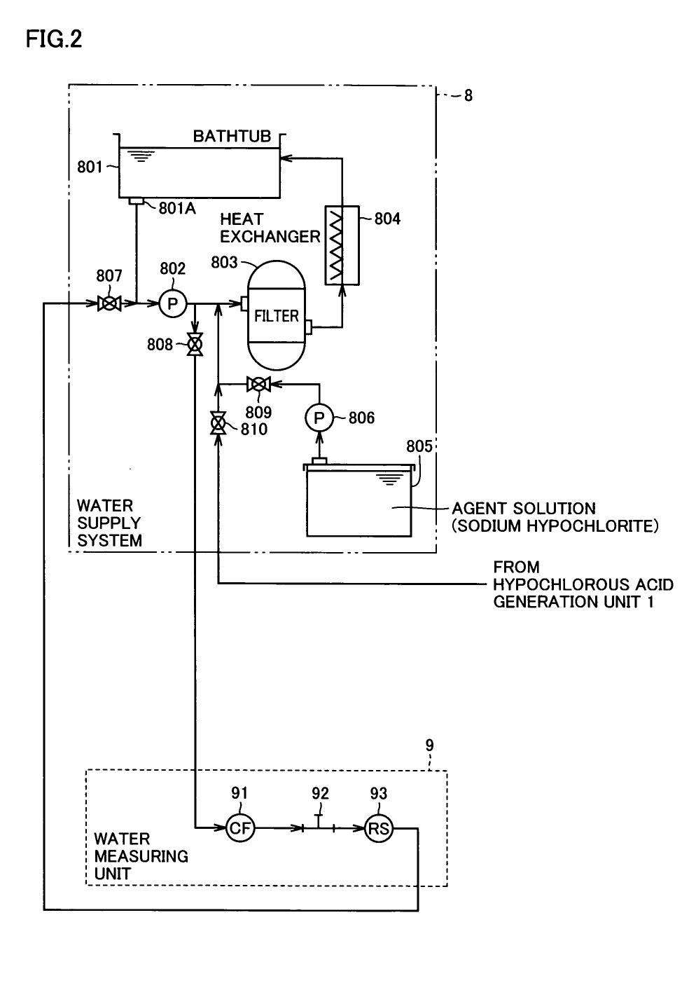

A functional configuration of a water processing system will be described with reference to FIGS. 1 and 2 in which arrows indicate the piping and flow through which liquid or gas pass through.

In the water processing system, water from tap water or the like is supplied as the water to be treated to the electrolytic water generation apparatus. The electrolytic water generation apparatus applies electrolysis on the water to be treated to generate hypochlorous acid in the water to be treated. The electrolytic water generation apparatus supplies the under-treating water now including hypochlorous acid by electrolysis to another apparatus such as a water supply system and the like.

The electrolytic water generation apparatus is mainly constituted of a hypochlorous acid generation unit 1 and an electrolysis accelerator tank 5. Water to be treated is introduced from a predetermined water supply source such as the city water to hypochlorous acid generation unit 1 via a valve 40.

Hypochlorous acid generation unit 1 includes a water tank 17. Water tank 17 includes inlets 17A, 17B, and an outlet 17C. In hypochlorous acid generation unit 1, the water to be treated introduced via valve 40 is delivered to water tank 17 via inlet 17A to be stored therein. A float 17D is provided in water tank 17. Float 17D is provided so as to float on the water in water tank 17 and to close inlet 17A when the water level of the water to be treated in water tank 17A arrives at a predetermined water level.

Hypochlorous acid generation unit 1 includes an electrolytic bath 10. Electrolytic bath 10 includes an inlet 10A, an exhaust port 10B, an outlet 10C, and an overflow port 10D. At the time of cleaning the interior of electrolytic bath 10, outlet 10C is opened to allow the solution in electrolytic bath 10 to be output. Following closure of outlet 10C, a pump 18 is driven or a valve 19 is set open, whereby the water in water tank 17 is introduced into electrolytic bath 10 via inlet 10A.

A plurality of electrode pairs 11 are provided in electrolytic bath 10 so as to be immersed in the water to be treated in electrolytic bath 10. Electrode pair 111 is constituted of a plurality of electrodes including an anode electrode and a cathode electrode. In hypochlorous acid generation unit 1, power is supplied from an external direct current power supply 15 to electrode pair 11. A thermistor 33 to detect the temperature of the water in electrolytic bath 10 is provided in electrolytic bath 10.

Electrolysis accelerator tank 5 includes an electrolysis accelerator bath 50. Saturated sodium chloride solution is stored in electrolysis accelerator bath 50. Electrolysis accelerator bath 50 includes an inlet 51 and an outlet 52. A water level sensor 53 and a thermistor 56 are provided in electrolysis accelerator bath 50. Electrolysis accelerator tank 5 includes a pump 54 to deliver to electrolytic bath 10 the saturated sodium chloride solution in electrolysis acceleration bath 50, and an electromagnet valve 55 to control supply of the water to be treated, likewise hypochlorous acid generation unit 1, to electrolysis accelerator bath 50. The water to be treated is introduced into electrolysis accelerator bath 50 via electromagnet valve 55 and inlet 51. The manner of introduction of the water to be treated into electrolysis accelerator bath 50 is modified in accordance with the change of the opening/closure status of electromagnetic valve 55. When detection is made by water level sensor 53 that the water level of the solution in electrolysis accelerator bath 50 has arrived at a predetermined water level, outlet 52 is set open. Accordingly, the solution in electrolysis accelerator bath 50 is exhausted to the drain via outlet 52 such that the solution in electrolysis accelerator tank 5 does not exceed the predetermined water level.

In electrolytic bath 10, power is supplied to electrode pair 11, and saturated sodium chloride solution is applied from electrolysis accelerator tank 5, whereby the water to be treated is electrolyzed. By the electrolysis in electrolytic bath 10, hypochlorous acid can be generated in the water to be treated in electrolytic bath 10. The chemical reaction predicted in the electrolysis in electrolytic bath 10 will be described hereinafter.

In the water to be treated in electrolytic bath 10, balance is established of formulas (1) and (2) set forth below by adding saturated sodium chloride solution.
H₂O [symbol] H⁺+OH⁻ (1)
NaCl [symbol] Na⁺+Cl⁻ (2)

As represented by formulas (3)-(5) set forth below, in the proximity of the anode electrode of electrode pair 11, oxygen gas is generated by the electrolysis of water, and chloride ions become chlorine gas, which is partially hydrated to become hypochlorous acid.
2H₂O [symbol] O₂↑+4H⁺+4e⁻ (3)
2Cl [symbol] Cl₂↑+2e⁻ (4)
Cl₂+H₂O [symbol] H⁺+Cl⁻+HClO (5)

As represented by formulas (6) and (7), in the proximity of the cathode electrode of electrode pair 11, hydrogen gas is generated by the electrolysis of water, and sodium ions generated at the anode electrode react with hydroxide ions to result in generation of sodium hydroxide.
2H₂O+2e⁻ [symbol] H₂↑+2OH⁻ (6)
Na⁺+OH³¹ [symbol] NaOH (7)

Accordingly, in the proximity of the cathode electrode, sodium hydroxide is generated, and the water to be treated is rendered alkaline.

Respective types of gas generated in accordance with the formulas set forth above pass through the piping connected to exhaust port 10 to be guided outside hypochlorous acid generation unit 1. Such gas discharge is accelerated by the drive of a blower motor 14 provided above the piping.

Hypochlorous acid generation unit 1 includes a reservoir 12, outside electrolytic bath 10, to store the overflowing water from electrolytic bath 10 via overflow port 10D. Reservoir 12 includes outlets 12A-12C. When the water in reservoir 12 exceeds a predetermined water level, the water will overflow from outlet 12A to be discharged to the drain. When a valve 32 attains an open state, the water in reservoir 12 is output to the drain via outlet 12B. A water level sensor 13 to detect the water level of the water in reservoir 12 is provided in reservoir 12. Valve 32 is set open under the condition of, for example, the water level detected by water level sensor 13 exceeding a predetermined water level.

When a valve 24 attains an open state, the water in reservoir 12 is introduced via outlet 12C appropriately to a tank 6, a chlorine agent tank 7 and the like, provided outside hypochlorous acid generation unit 1. Tank 6 and chlorine agent tank 7 are examples of the tanks to store the hypochlorous acid generated at hypochlorous acid generation unit 1. Tank 6 includes a storage bath 60, a valve 61 adjusting the introducing amount of water to be treated into storage bath 60, and a valve 62 adjusting the discharging amount of water from storage bath 60. The water in storage bath 60 is delivered to the desired site by the drive of a pump 20 or a pump 25. When the water stored in storage bath 60 exceeds a predetermined amount, the water is output outside to a drain via valve 62 or an overflow opening 60A formed in storage bath 60. Chlorine agent tank 7 includes a storage bath 70 storing the water generated at hypochlorous acid generation unit 1 together with sodium hypochlorite, and a valve 71 adjusting the introducing amount of water into storage bath 70.

Pumps such as pump 20, pump 25 and the like are connected to outlet 12C of reservoir 12. The drive of a relevant pump causes the water in reservoir 12 to be introduced appropriately to the apparatus connected to the relevant pump. Additional pumps, denoted as pumps 21-23, can also be connected to outlet 12C.

Although not shown, electrolytic bath 10 and reservoir 12 are accommodated in a substantially sealed state in a predetermined casing in hypochlorous acid generation unit 1. The aforementioned piping connected to exhaust port 10B of electrolytic bath 10 extends outside hypochlorous acid generation unit 1 so as to pierce the casing. In the casing, a hydrogen gas sensor 16 to detect the concentration of hydrogen gas is provided outside electrolytic bath 10 in the proximity of exhaust port 10B. Hydrogen gas is generated in accordance with the electrolysis conducted in electrolytic bath 10, as mentioned above. Respective types of gases such as this hydrogen gas are output outside the electrolytic bath and the casing in which the electrolytic bath is accommodated by the drive of blower motor 14. When blower motor 14 is not driven properly due to failure or the like at hypochlorous acid generation unit 1, this abnormal event is recognized by the increase in the concentration of hydrogen gas detected by hydrogen gas sensor 16. It is to be noted that the electrolytic water generation apparatus of the present embodiment includes a control circuit (control circuit 100 that will be described afterwards) controlling the entire operation of the electrolytic water generation apparatus. The control circuit functions to inhibit power supply to electrode pair 11 to stop the electrolysis when the concentration of hydrogen gas detected by hydrogen gas sensor 16 exceeds a predetermined level.

A main drain 30 is provided in hypochlorous acid generation unit 1. In case that leakage occurs at electrolytic bath 10 or reservoir 12 in hypochlorous acid generation unit 1, the leaking waste is collected in main drain 30. The waste gathered in main drain 30 is delivered to an appropriate site.

The electrolytic water generation apparatus of the present embodiment supplies water to be treated including hypochlorous acid to a water supply system 8 via pump 20. Water supply system 8 includes a bath 801 constituted of, for example, a bathtub, an outlet 801A provided in bath 801, a sand filter 803 through which water output from outlet 801A is filtered, a pump 802 to accelerate the flow of water from outlet 801A to sand filter 803, a heat exchanger 804 through which the water output from sand filter 803 passes before returning to bath 801, a chemical agent supply bath 805 to supply a chemical agent such as hypochlorous acid into the water in bath 801, and a pump 806 to deliver the chemical agent in chemical agent supply bath 805 into the pump to be mixed with the water output from tank 801.

At the site where the chemical agent output from agent supply bath 805 is mixed with the water output from bath 801, the water to be processed delivered from hypochlorous acid generation unit 1 is also mixed with the water output from bath 801. It is to be noted that chemical agent supply bath 805 is a bath to add hypochlorous acid to the water output from bath 801. Therefore, appropriate adjustment of valve 809 and valve 810 allows the water to be treated from hypochlorous acid generation unit 1 and/or the chemical agent in bath 805 to be mixed with the water output from bath 801 such that the required amount of hypochlorous acid is added to the water output from bath 801. Thus, the water output from bath 801 is added with hypochlorous acid prior to introduction to sand filter 803. The water with hypochlorous acid added passes through sand filter 803 and heat exchanger 804 to return to bath 801 again.

The water temporarily output from bath 801 is appropriately carried to a water measuring unit 9 through the opening operation of a valve 808. At water measuring unit 9, the water is filtered through a cartridge filter 91, has the flow rate adjusted by a constant flow valve 92, and then introduced to a residual chlorine concentration sensor 93 to have the residual chlorine concentration detected. In water supply system 8, the open and closure status of valve 810 and/or valve 809 is controlled in accordance with the residual chlorine concentration detected at water measuring unit 9, whereby control is executed so that the residual chlorine concentration of the water in tank 801 is within a preferable range.

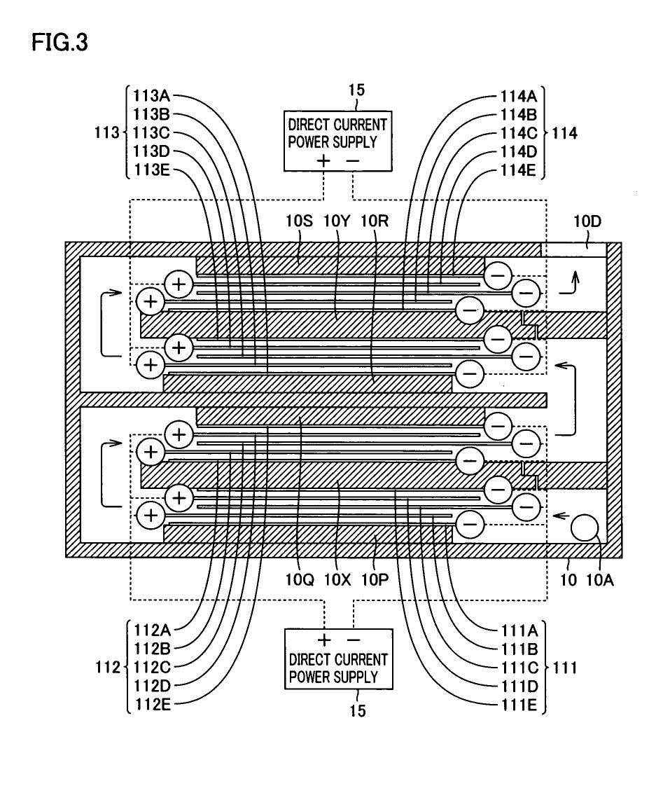

The arrangement of electrodes in electrolytic bath 10 will be described with reference to FIG. 3. FIG. 3 is a top view of electrolytic bath 10 viewed from above with the lid removed. The arrow in FIG. 3 represents the flow of water to be treated.

In electrolytic bath 10 are arranged four electrode pairs, i.e. electrode pairs 111-114, as a specific example of electrode pair 11 (refer to FIG. 1). In other words, electrode pairs 111-114 constitute electrode pair 11 of FIG. 1.

Electrode pairs 111-114 include five electrodes 111A-111E, 112A-112E, 113A-113E, and 114A-114E, respectively. The five electrodes of each electrode pair are disposed in the order of a cathode electrode, an anode electrode, a cathode electrode, an anode electrode, and a cathode electrode. Electrodes 111A-111E, 112A-112E, 113A-113E, and 114A-114E constituting electrode pairs 111-114 have power supplied from a direct current power supply 15. In FIG. 3, the broken line represents the wiring connecting the electrodes with direct current power supply 15.

Inner walls 10P, 10Q, 10R, 10S, 10X and 10Y are provided appropriately in electrolytic bath 10. Accordingly, the water to be treated introduced into electrolytic bath 10 from inlet 10A sequentially passes through electrode pair 111, electrode pair 112, electrode pair 113 and electrode pair 114 to be output from electrolytic bath 10 via overflow port 10D. In the present embodiment, overflow port 10D constitutes the outlet from which water subjected to electrolysis in the electrolytic bath of the present invention is output. The path from inlet 10A to overflow port 10D in electrolytic bath 10 through which the water to be treated flows constitute the water channel from the inlet towards the outlet of the electrolytic bath of the present invention.

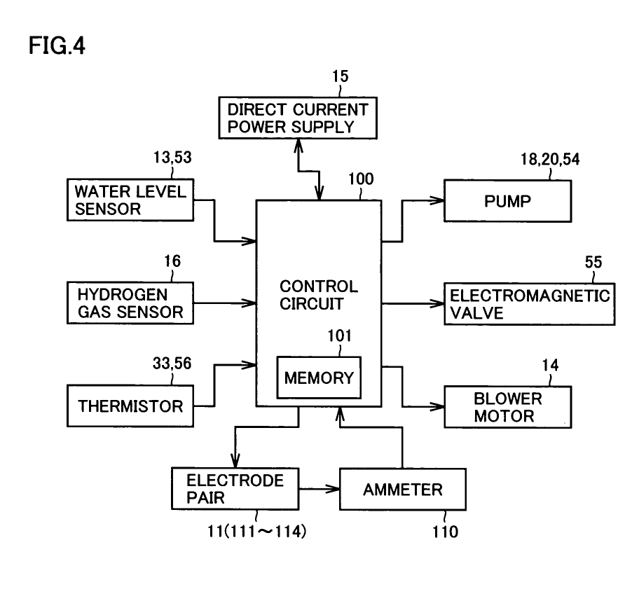

Referring to FIG. 4, an electrolytic water generation apparatus of the present embodiment includes a control circuit 100 providing entire control of the operation of the electrolytic water generation apparatus. Control circuit 100 includes a memory 101 in which various information is stored, such as a processing program to be executed by control circuit 100 as will be described afterwards, the detected output of various measuring devices in the electrolytic water generation apparatus and the like.

To control circuit 100 are provided respective detected outputs from water level sensors 13 and 53, hydrogen sensor 15, and thermistors 33 and 56. Hypochlorous acid generation unit 1 includes an ammeter 110 to detect the value of current flowing across an anode electrode and a cathode electrode in respective electrode pairs 111-114. The current value detected by ammeter 110 is applied to control circuit 100. The current value of respective electrode pairs 111-114 detected by ammeter 110 refers to the value of current in the circuit where the electrodes included in respective electrode pairs 111-114 are aligned in series. Specifically, the current value detected with respect to electrode pair 111, for example, refers to the current value in the circuit where the five electrodes of 111A, 111B, 111C, 111D and 111E are sequentially disposed in series.

Furthermore, control circuit 100 controls the supply of power from direct current power supply 15 to electrode pair 11 (electrode pairs 111-114), and also the operation of pumps 18, 20 and 54, electromagnetic valve 55, and blower motor 14.

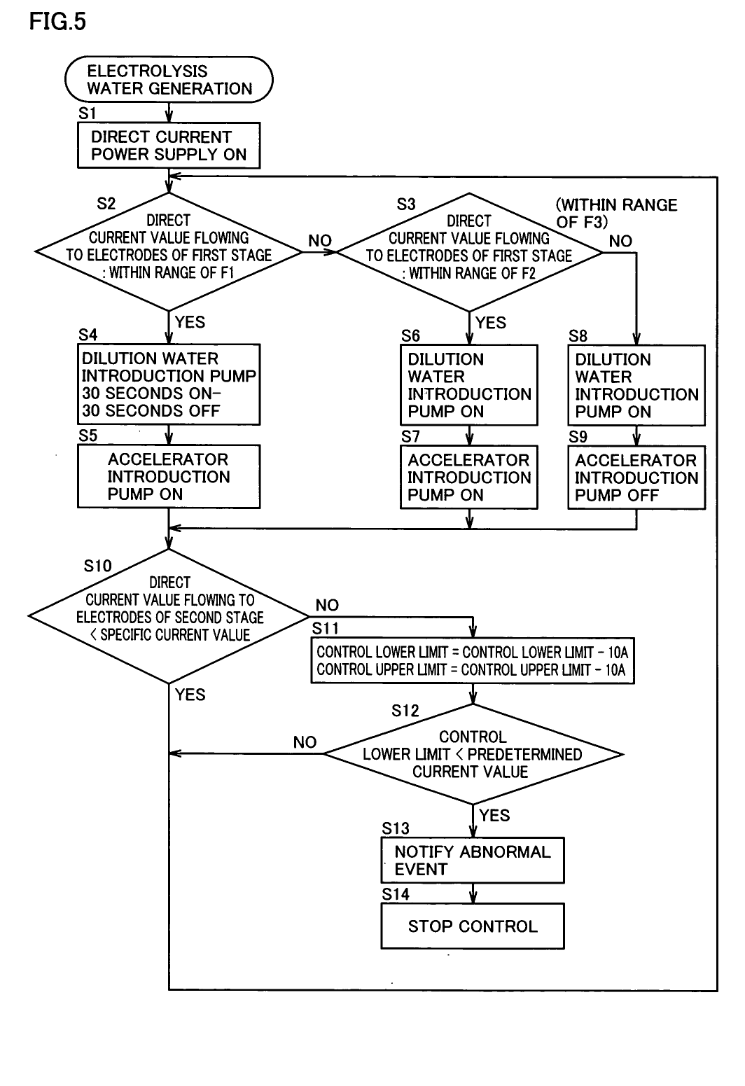

The operation of the electrolytic water generation apparatus when electrolysis is executed in electrolytic bath 10 by control circuit 100 will be described with reference to FIG. 5.

When water to be treated of a predetermined amount is introduced into electrolytic bath 10, direct current power supply 15 is turned ON at S1 (step abbreviated as S hereinafter) to initiate power supply from direct current power supply 15 to electrode pair 11.

At S2, control circuit 100 identifies the value of direct current flowing to the electrodes of the first stage in electrolytic bath 10 (the electrodes constituting the electrode pair most upstream of the water channel in electrolytic bath 10; specifically electrodes 111A-111E of electrode pair 111).

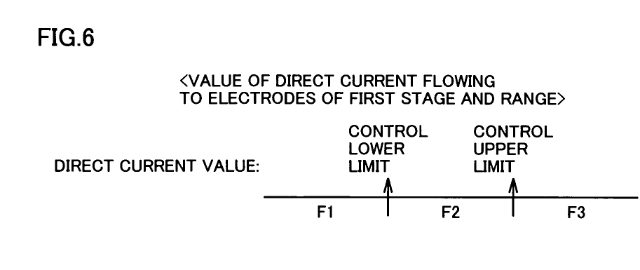

As schematically shown in FIG. 6, contents that become the basis of determination for a subsequent process with respect to the current value of the first stage of electrodes are stored in memory 101. The determination criteria shown in FIG. 6 will be described hereinafter. In FIG. 6, the direct current value is divided into the three ranges of F1, F2 and F3, starting from the lower value. In FIG. 6, the range of the direct current value up to the control lower limit is identified as F1, the range of the direct current value equal to or greater than the control lower limit and not more than the control upper limit is identified as F2, and the range of the direct current value exceeding the control upper limit is identified as F3. The control lower limit and control upper limit are values determined for each environment corresponding to hypochlorous acid generation unit 1.

At S2, determination is made by control circuit 100 as to whether the identified direct current value is within the range of F1. If the value is within the range of F1, control proceeds to S4, otherwise, to S3.

At S3, determination is made by control circuit 100 as to whether the direct current value identified at S2 is within the range of F2 or not. When the value is within the range of F2, control proceeds to S6, otherwise, to S8. In other words, when determination is made that the identified direct current value is within the range of F3, control proceeds to S8.

At S4, control circuit 100 provides control such that pump 18 identified as the pump to introduce dilution water is operated to be turned ON 30 seconds and turned OFF 30 seconds. At S5, pump 54 identified as the pump to introduce an electrolysis accelerator is operated continuously. Then, control proceeds to S10. An electrolysis accelerator implies a chemical agent to accelerate electrolysis, and is sodium chloride in the present embodiment. The electrolysis accelerator that can be used in the present invention is not limited to sodium chloride, and may include another compound agent that can supply chloride ions into the solution such as potassium chloride.

At S6, control circuit 100 operates pump 18 continuously, and also operates pump 54 continuously at S7. Then, control proceeds to S1.

At S8, control circuit 100 operates pump 18 continuously, and then suppresses the operation of pump 54 (turned OFF) at S9. Then, control proceeds to S10:

In the steps of S2-S10, the electrolysis accelerator is continuously applied to electrolytic bath 10 whereas the dilution water is applied only discontinuously when the current value of the electrodes at the first stage is lower than the range of F2. When the current value is within the range of F2, both the electrolysis accelerator and dilution water are applied continuously into electrolytic bath 10. When the value is higher than the range of F2, the dilution water is applied into electrolytic bath 10 whereas the electrolysis accelerator is not.

Accordingly, control is provided such that the current value of the electrodes of the first stage is within the range of F2. Specifically, when the current value of the electrodes of the first stage is lower than the range of F2, control is provided such that the concentration of the electrolysis accelerator in electrolytic bath 10 is increased to achieve a higher current value. When the current value of the electrodes at the first stage is higher than the range of F2, control is provided such that the concentration of the electrolysis accelerator electrolytic bath 10 is reduced to achieve a lower current value.

At S10, control circuit 10 identifies the value of current flowing to the electrodes of the second stage in the water channel (electrodes 112A-112E constituting electrode pair 112 in the present embodiment). As the criteria for determination with respect to the current value of the electrodes of the second stage, a specific current value determined in addition to the aforementioned control upper limit and control lower limit of FIG. 6 is prestored in memory 101. At S10, determination is made by control circuit 100 as to whether the identified current value of the electrodes of the second stage is below the specific current value. When determination is made that the value is below the specific value, control returns to S2. When determination is made that the value is equal to or higher than the specific current value, control proceeds to S11.

At S11, control circuit 100 modifies the control upper limit and the control lower limit of the electrodes of the first stage shown in FIG. 6 to values lowered respectively by 10A (ampere), and control proceeds to S12.

At S12, determination is made as to whether the control lower limit modified at S11 is lower than a predetermined current value. When determination is made by control circuit 100 that the modified control lower limit is below the predetermined current value, control circuit 100 provides control such that the abnormal event is notified by audio or display at S13, and suppresses the control of electrolysis such as by inhibiting power supply to electrode pair 11 at S14. On the other hand, when determination is made by control circuit 100 that the modified control lower limit is equal to or above the predetermined current value, control returns to S2.

### Second Embodiment

In the previous first embodiment, control is provided such that the current value of the electrodes of the first stage in electrolytic bath 10 is within a predetermined range (the range of F2) by adjusting the electrolysis accelerator added into electrolytic bath 10 to control the concentration of the electrolysis accelerator in electrolytic bath 10 in the electrolytic water generation apparatus of FIG. 1, as described with reference to FIGS. 5 and 6 in particular.

In the second embodiment, the introducing amount of the electrolysis accelerator is adjusted when pump 54 identified as the pump for introducing the electrolysis accelerator is ON in accordance with the temperature of the electrolysis accelerator (saturated sodium chloride solution) in electrolysis accelerator bath 50 so that the concentration of the electrolysis accelerator is adjusted further properly in an electrolytic water generation apparatus having a configuration similar to that of the first embodiment. The amount of introduction during an ON mode of pump 54 is adjusted in accordance with the temperature of the electrolysis accelerator since the concentration of the saturated sodium chloride solution varies in accordance with the temperature. Also, the introducing amount in an ON mode of pump 54 is adjusted by controlling the power applied to pump 54 per unit time.

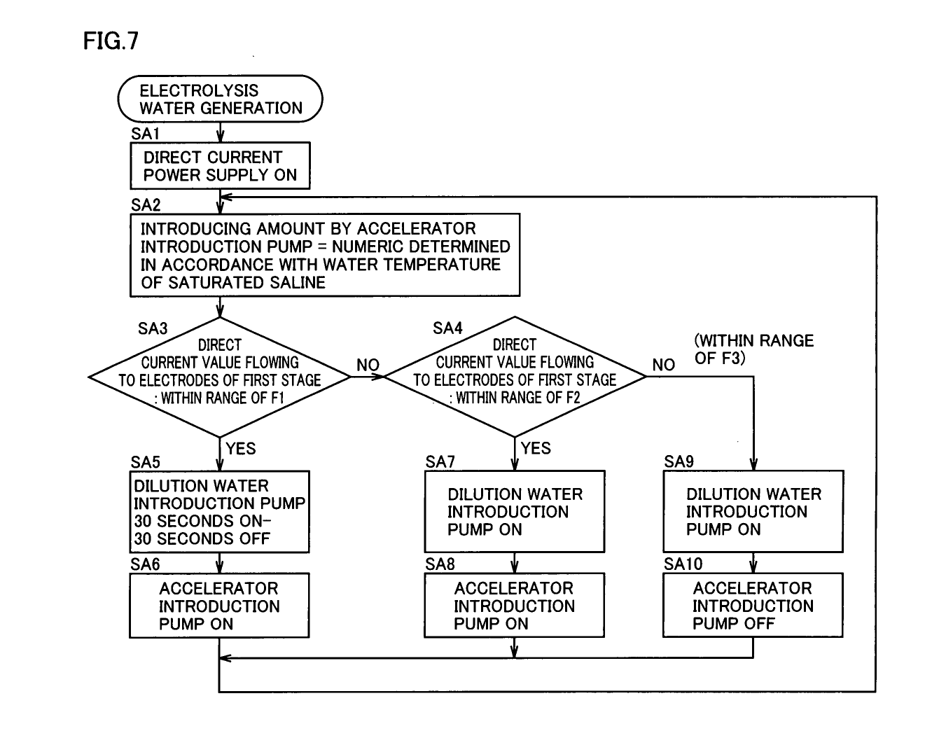

The operation of the electrolytic water generation apparatus of the present embodiment when electrolysis is executed at electrolytic bath 10 will be described with reference to FIG. 7.

When a predetermined amount of water to be treated is introduced into electrolytic bath 10, direct current power supply 15 is turned ON at SA1, whereby power supply to electrode pair 11 from direct current power supply 15 is initiated.

At SA2, control circuit 100 detects the temperature of the saturated sodium chloride solution in electrolysis accelerator bath 50, and alters the power applied to pump 54 such that the introducing amount by pump 54 identified as the pump to introduce the electrolysis accelerator corresponds to the detected temperature. The temperature of the saturated sodium chloride solution in electrolysis accelerator bath 50 and the introducing amount by pump 54 are stored in corresponding relationship in memory 100 in a table format. Control circuit 100 refers to the table and the like stored in memory 100 to execute the process of SA2. In the table or the like stored in memory 101, the introducing amount by pump 54 is generally set such that the introducing amount becomes lower as the temperature of the saturated sodium chloride in electrolysis accelerator bath 50 becomes higher.

At SA3, control circuit 100 identifies the value of direct current flowing to the electrodes of the first stage in electrolytic bath 10. Determination is made as to whether the identified direct current value is within the range of F 1 (refer to FIG. 6). When the value is within the range of F1, control proceeds to SA5, otherwise, to SA4.

At SA4, determination is made by control circuit 100 as to whether the direct current value identified at SA3 is within the range of F2 (refer to FIG. 6). When the value is within the range of F2, control proceeds to SA7, otherwise, to SA9. Namely, control proceeds to SA9 when determination is made that the identified direct current value is in the range of F3 (refer to FIG. 6).

At SA5, control circuit 100 provides control such that pump 18 identified as the pump for introducing dilution water is turned ON 30 seconds and turned OFF 30 seconds. At SA6, pump 54 identified as the pump for introducing the electrolysis accelerator is operated continuously, and control returns to SA2.

At SA7, control circuit 100 operates pump 18 continuously, and also operates pump 54 continuously at SA8. Then, control returns to SA2.

At SA9, control circuit 100 operates pump 18 continuously, and then stops the operation of pump 54 (turned OFF) at SA19. Then, control returns to SA2.

In the embodiment set forth above, the introducing amount of the electrolysis accelerator by pump 54 continuously corresponds to the temperature of the electrolysis accelerator in electrolysis accelerator bath 50 during execution of electrolysis.

Although the present invention has been described and illustrated in detail, it is clearly understood that the same is by way of illustration and example only and is not to be taken by way of limitation, the spirit and scope of the present invention being limited only by the terms of the appended claims.

1. An electrolytic water generation apparatus comprising:
an electrolytic bath storing water to be treated,
said electrolytic bath including an inlet through which the water to be treated is introduced, and an outlet from which the water to be treated subjected to electrolysis in said electrolytic bath is output,
a plurality of electrode pairs arranged along a water channel from said inlet to said outlet in said electrolytic bath,
a power supply control unit providing control such that a predetermined amount of power is applied to each of said plurality of electrode pairs,
a chemical agent supply unit supplying a chemical agent to accelerate electrolysis of the water to be treated by said electrode pair in said electrolytic bath,
a current value detection unit detecting a first current value that is the value of current flowing across electrodes constituting an electrode pair arranged most upstream of said water channel among said plurality of electrode pairs, and a second current value that is the value of current flowing across electrodes constituting another electrode pair differing from said electrode pair arranged most upstream when said predetermined power is supplied to each of said plurality of electrode pairs, and
a chemical agent amount control unit controlling an amount of chemical agent supplied by said agent supply unit such that said first current value is within a predetermined range,
wherein said chemical agent amount control unit modifies, when said second current value becomes at least a specific current value, an upper limit and a lower limit defining said predetermined range to lower values thereof.

2. The electrolytic water generation apparatus according to claim 1, further comprising an abnormal event notify unit notifying an abnormal event based on a condition that the lower limit of said predetermined range after modification by said chemical agent amount control unit becomes lower than a predetermined value.

3. The electrolytic water generation apparatus according to claim 1, wherein said chemical agent to accelerate electrolysis of the water to be treated is a chemical agent supplying chloride ions into the water to be treated.

4. The electrolytic water generation apparatus according to claim 3, wherein said chemical agent to accelerate electrolysis of the water to be treated is sodium chloride.

5. An electrolytic water generation apparatus comprising:
an electrode pair,
an electrolytic bath storing said electrode pair and water to be treated,
a chemical agent supply unit supplying a solution of a chemical agent to promote electrolysis of the water to be treated by said electrode pair in said electrolytic bath,
a chemical agent temperature detection unit detecting a temperature of the solution supplied by said chemical agent supply unit, and
a chemical agent amount control unit controlling a supplied amount of solution of the chemical agent in said electrolytic bath by said chemical agent supply unit based on the temperature detected by said chemical agent temperature detection unit.

6. The electrolytic water generation apparatus according to claim 5, wherein said chemical agent to accelerate electrolysis of the water to be treated is a chemical agent supplying chloride ions into the water to be treated.

7. The electrolytic water generation apparatus according to claim 6, wherein said chemical agent to accelerate electrolysis for the water to be treated is sodium chloride.
